(19) United States
(12) Patent Application Publication
(10) Pub. No.: US 2005/0252489 A1
(43) Pub. Date: Nov. 17, 2005

(54) Variable octane duel fuel delivery system

(76) Inventor: John A. Moody, Washington, DC (US)

Correspondence Address: Roylance Abrams;Berdo & Goodman, Suite 600, 1300 19th Street NW, Washington, DC, 20036, US

(21) Appl. No.: 10/509,188

(22) PCT Filed: Mar. 26, 2002
(86) PCT No.: PCT/US02/06659

§ 371 Date: May 16, 2005

(51) Int. Cl. F02D 41/14; F02M 7/00

(52) U.S. Cl. 123/435

(57) ABSTRACT

Variable octane gasoline fuel system which includes two different octane gasoline fuels, each stored in its own separate vehicle-mounted tank or compartment. These separately-stored high and low octane fuels a mixed, for example, in the vehicle's fuel injection system in proportion as necessary to meet the anti-knock requirement according to instantaneous engine load. The percentage of each octane can be controlled by the pressure in the intake Manifold and other factors.

### FIELD OF THE INVENTION

A method of creation and use of a variable octane gasoline system as applied to gasoline-powered motor vehicles.

### DESCRIPTION OF THE RELATED ART

Various systems for breaking gasoline down into two different octanes, sometimes stored in separate tanks thereafter, have been previously described (see, for example, U.S. Pat. No. 6,308,682, U.S. Pat. No. 5,524,582, U.S. Pat. No. 6,119,637, U.S. Pat. No. 6,311,649, U.S. Pat. No. 5,927,255, U.S. Pat. No. 6,332,448). All of these references focus on the process of breaking the gasoline into high and low octane components. That is, most of these systems use heat to boil and then condense the gasoline—in effect making the vehicle a moving gasoline refinery.

The problems associated with such systems are at the very least—complexity of the system to be implemented in a vehicle and danger of on-board distilling

### SUMMARY OF THE INVENTIONS

The present invention overcomes the above-noted drawbacks of the conventional system designs by providing a system which benefits from the efficiency of using variable octane gasoline to power a vehicle, while avoiding the complexities associated with on-board fuel heating and boiling, and the safety concerns associated with on-board distilling.

The proposed system would draw two different octane gasoline fuels, each stored in its own separate vehicle-mounted tank, and mix these high and low octane fuels in, for example, the fuel injection system in proportion as necessary to meet the anti-knock requirement according to instantaneous engine load; the percentage of each octane being controlled by the pressure in the intake manifold and other factors.

### BRIEF DESCRIPTION OF THE DRAWINGS

FIG. 1—is block diagram showing an illustative example of components of a fuel system according to the present invention.

FIG. 2—is an illustative example of a fuel tank according to an embodimetn of the present invention.

FIG. 3—is an illustatrive example of a fuel tank configuration according to another embodiment of the invention.

FIG. 4—is an illustrative example of fill pipe configuration for a fuel tank configuration according to another embodiment of the invention.

### DESCRIPTION OF THE PREFERRED EMBODIMENTS

A gasoline fueled, internal combustion engine can only generate pressure in its combustion chamber on the firing stroke in relation to the absolute pressure (below the throttle butterfly) existing in its intake manifold at any given moment.

If the induction path is unrestricted, as is the case when the throttle butterfly is fully open, i.e., parallel to the airflow, only then will the maximum combustion chamber pressure be realized as per designed compression ratio.

All things being equal, as an illustration at fully open throttle, an engine with a compression ratio of 10:1 can be expected to develop a chamber pressure of 10 atmospheres, or 147 psi under maximum standard conditions.

At the other extreme, again for illustration, if the engine is idling with the throttle butterfly at right angles to the airflow, only minimum air can enter the manifold and the absolute pressure in that manifold downstream will be as low as only a few psi positive. And with the same 10:1 designed compression ratio, the pressure in the combustion chamber will be correspondingly reduced by as much as ⅔rds or more.

Consequently, in an idling engine with a 10:1 compression ratio, the pressure in the chamber at the top of the compression stroke will be only roughly ⅓rd of one atmosphere (5 psi) or less, times ten—or 50 psi or lower.

At this minimum chamber pressure there can be no justification nor need for premium (93/94 M+R/2) octane gasoline whatever, and its use is obviously gross overkill and wasteful of money and resources.

Current engines may be specified to use only high octane gasoline (93/94 M+R/2 octane) at all times merely to prevent detonation under full throttle applications. There is no requirement for such premium octane gasoline under less than full throttle operation.

All operation of the engine can only vary within these two limits, full throttle and idling conditions. So the question then becomes how much of actual driving time on the road is under what throttle position and at what intake manifold pressures?

Real-world measurements show that under level, steady state interstate highway conditions, there will be only some 7-10 psi positive pressure in the intake manifold during some 85% or 90% of the time on the road.

Which means that 85-90% of normal driving conditions will be done with only some 50-100 psi in the combustion chamber with no justification for use of 91/94 M+R/2 octane high test, premium gasoline under these operating conditions. A lower octane number gasoline is deemed far more appropriate under such operating conditions.

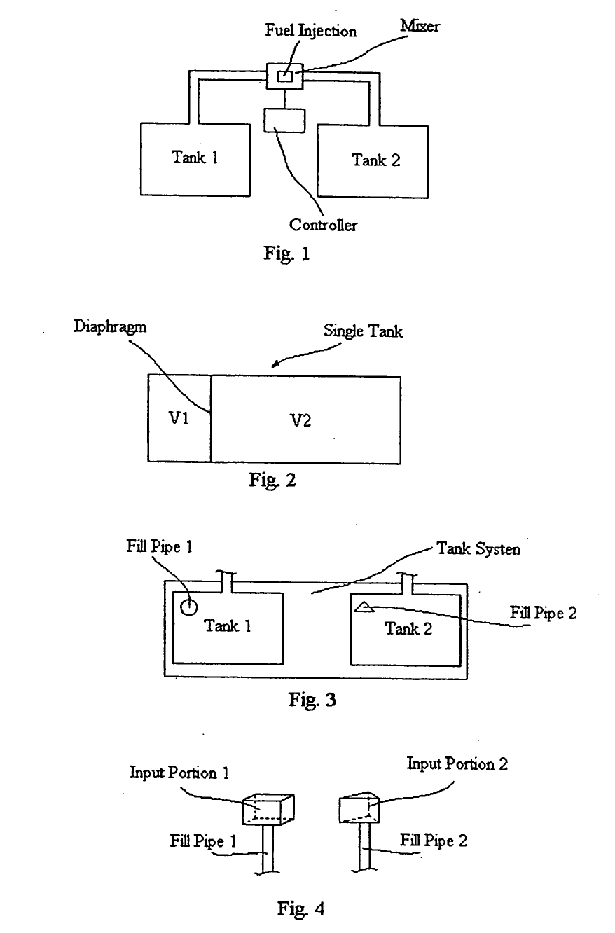

According to preferred embodiments of the present invention, as shown in FIGS. 1, 2 and 3, an on-board system would require a duel fuel tank arrangement on a vehicle, which arrangement can include either a single tank with a dividing diaphragm (FIG. 2), or two separate tanks (FIGS. 1 and 3).

In a particularly advantageous embodiment of the invention, the tank (or compartment) which contains higher octane fuel is configured to have a smaller volume than the other tank (or compartment), as diagrammatically shown in FIG. 2 (see volumes V1 and V2). Also, one of the tanks (or one of the fuel compartments in the case of a single tank with a dividing diaphragm) may be advantageously equipped with a unique fill pipe configuration, as shown (cross-section view of configurations of the fill pipes 1 and 2) in Tank 2 of FIG. 3. For example, fill pipes 1 and 2 may differ in cross-sectional shape or size at least at a portion which receives fuel from an external source, e.g., from a conventional gasoline pump. As shown on FIG. 4, the fill pipes may be identical, thus making manufacturing thereof more economical, but have unique input portions 1 and 2, which maybe metal, molded plastic, or other appropriate material, integrally formed thereon, or removably attached thereto.

Other appropriate hardware and software items in a form of, for example, an electronic circuit (graphically illustrated as “Controller” in FIG. 1) and a “Mixer”, to work in conjunction with a vehicle's fuel management system to provide the optimum octane mix as engine power demands. While FIG. 1 shows the mixer arranged integrally, or in close proximity to the controller, other arrangements and configurations of a mixer which may be responsive to a controller are possible without departing from the scope of the invention, so long as the mixer is arranged to receive input form both tanks (or compartments in the case of a single tank with a dividing diaphragm) ant to provide appropriate octane mix at its output.

It is anticipated the larger tank, containing the low cost, low octane fuel would carry 85%-90% of the total fuel on board, with only 10%-15% of the highest, costly, premium grade being carried in the second tank.

The system is easily adaptable for use with existing gas pumps now at highway service stations during an interim period when both new-design and older vehicles can be expected to share the service stations for perhaps a 20 year transition period, after which the final new octane fuels can be made available as required by the dual octane vehicles in accordance with the present invention.

At present no known, or extremely few if any, automobile manufacturers call for use of 89 octane gasoline. Hence, the 89 octane gas pumps can be considered superfluous. Consequently, immediately and during the interim period, these existing 89 octane pumps can be converted to supply a new, economical low grade base octane fuel of, say 50 octane or so, requiring only a nozzle modification to a unique configuration fitting into only the new corresponding fill inlet on the new dual tank vehicles; into the larger of the two tanks.

Older automobiles on the road can continue to be fueled from the other two existing regular (87 octane) and premium (93/94 octane) pumps. The modified nozzles of the old 89 octane pumps will not fit into the older generation tank inlets.

At the end of the transition period when the majority of the vehicles on the roads are essentially all new dual-tank design, the existing 87 octane pumps may be relegated to a few stations still servicing the remaining older and collector vehicles and farm machinery/industrial engines designed for 87 octane fuel.

The original 89 octane pumps, as converted to supply low 50 octane gasoline, can continue in service beyond the transition period without change.

The present premium 93/94 octane pumps can be converted to supply a new even higher octane fuel—perhaps 100 M+R/2 octane or higher—allowing for even more efficient, future high power engine designs. Such fuel use will be in far smaller quantities than of today's 93/94 high octane fuel, as it will be required only under full or heavy throttle conditions, as described above.

Finally, should either tank on the vehicle run dry of fuel, the system will draw from whichever tank has fuel remaining. Should a high-performance engine of necessity be run on the low octane base gasoline the existing knock sensor system will automatically engage to eliminate any engine detonation due to the lower octane fuel until a gas station can be reached.

Conversely, should the vehicle run out of the low octane, base grade fuel, the engine will run quite satisfactorily on the high octane fuel in the second tank until a gas station can be reached.

The variable octane, on-board, system according to the present invention is also environmentally friendly in that current unnecessary large requirement for quantity production of expensive high test premium gasolines can be very greatly reduced.

Conversely, a larger proportion of the low octane, base grade gasoline would be required with less drain on natural resources.

While various implementations of a vehicle-mounted system for supplying variable octain fuel in a accordance with the present invention have been described in detail, a skilled artisan will readily appreciate that numerous other implementations and variations of the design are possible without departing from the spirit of the invention. Accordingly, the scope of the invention is defined by the claims set forth below.

1. A fuel system for a gasoline-powered motor vehicle, said system comprising:
a first sub-tank for storing a first type fuel having a first octane rating;
a second sub-tank for storing a second type fuel having a second octane rating, said second octane rating being lower than said first octane rating;
a fuel mixer having a third type fuel as an output thereof, said third type fuel having a third octane rating which is a function of a mixture ratio of said first type fuel to said second type fuel;
a first supply line configured to deliver fuel from said first fuel tank to said mixer;
a second supply line configure to deliver fuel from said second tank to said mixer,
a controller connected to said mixer for controlling said mixture ratio.

2. The fuel system as claimed in claim 1, wherein a volume of said first sub-tank is smaller than a volume of said second sub-tank.

3. The fuel system as claimed in claim 1, wherein said first sub-tank and said second sub-tank are integrally formed as a single tank, said first sub-tank and said second sub-tank having a common wall separating a volume of said first sub-tank from a volume of said second sub-tank.

4. The fuel system as claimed in claim 3, wherein said wall is a rigid partition.

5. The fuel system as claimed in claim 3, wherein said wall is a flexible diaphragm.

6. The fuel system as claimed in claim 3, wherein said volume of said first sub-tank is smaller than a volume of said second sub-tank.

7. The fuel system as claims in claim 1 further comprising:
a first fill pipe having a first output configured to have access to said first sub-tank, and a first input to enable filling said first sub-tank with said first type fuel; and
a second fill pipe having a second output configured to have access to said second sub-tank, and a second input to enable filling said second sub-tank with said second type fuel.

8. The fuel system as claimed in claim 7, wherein at least a first portion of said first fill pipe is different from at least a second portion of said second fill pipe.

9. The fuel system as claimed in claim 8, wherein said first portion and said second portion are a first cross-section of said first input and a second cross-section of said second input, respectively.

10. The fuel system as claimed in claim 9, wherein said first cross-section and said second cross-section differ in shapes and/or sizes thereof.

11. The fuel system as claimed in claim 1, wherein said mixer is arranged upstream in a fuel flow direction from a fuel injector of said motor.

12. The fuel system as claimed in claim 1, wherein said mixer is an integral feature of a fuel injector of said motor, and said controller is connected to said fuel injector for controlling said mixture ratio at an output of said fuel injector.

13. The fuel system as claimed in claim 1, wherein said controller is configured to control said mixture ratio at least as a function of a compression ratio and/or a combustion chamber pressure of said motor.

14. A method of manufacturing a dual fuel system for a gasoline-powered motor vehicle, said system comprising:
forming a first sub-tank for storing a first type fuel having a first octane rating;
forming a second sub-tank for storing a second type fuel having a second octane rating, said second octane rating being lower than said first octane rating;
connecting said first sub-tank and said second sub-tank to a fuel mixer having a third type fuel as an output thereof, said third type fuel having a third octane rating which is a function of a mixture ratio of said first type fuel to said second type fuel; and
connecting a controller to said mixer for controlling said mixture ratio.

15. The method as claimed in claim 14, wherein a volume of said first sub-tank is smaller than a volume of said second sub-tank.

16. The method as claimed in claim 14, wherein said first sub-tank and said second sub-tank are integrally formed as a single tank, said method further comprising forming a wall in said single tank separating a volume of said first sub-tank from a volume of said second sub-tank.

17. The method as claimed in claim 16, wherein said wall is a rigid partition.

18. The method as claimed in claim 16, wherein said wall is a flexible diaphragm.

19. The method as claimed in claim 16, wherein said volume of said first sub-tank is smaller than a volume of said second sub-tank.

20. The method as claims in claim 14 further comprising:
connecting a first output of a first fill pipe to said first sub-tank;
configuring a first input of said first fill pipe to enable filling said first sub-tank with said first type fuel;
connecting a second output of a second fill pipe to said second sub-tank; and
configuring a second input of said second fill pipe to enable filling said second sub-tank with said second type fuel.

21. The method as claimed in claim 20, wherein at least a first portion of said first fill pipe is different from at least a second portion of said second fill pipe.

22. The method as claimed in claim 21, wherein said first portion and said second portion are a first cross-section of said first input and a second cross-section of said second input, respectively.

23. The method as claimed in claim 22, wherein said first cross-section and said second cross-section differ in shapes and/or sizes thereof.

24. The method as claimed in claim 14, further comprising arranging said mixer upstream in a fuel flow direction from a fuel injector of said motor.

25. The method as claimed in claim 14, further comprising integrally configuring said mixer with a fuel injector of said motor, wherein said controller is connected to said fuel injector for controlling said mixture ratio at an output of said fuel injector.

26. The method as claimed in claim 14, further comprising configuring said controller to control said mixture ratio at least as a function of a compression ratio and/or a combustion chamber pressure of said motor.

27. A method for operating a gasoline-powered motor vehicle, said method comprising:
filling a first sub-tank of said vehicle with a first type fuel having a first octane rating from a first source external to said vehicle;
filling a second sub-tank of said vehicle with a second type fuel having a second octane rating, said second octane rating being lower than said first octane rating, from a second source external to said vehicle;
storing said first type fuel in a first sub-tank;
storing said second type fuel in a second sub-tank;
delivering to a fuel mixer said first type fuel stored in said first sub-tank and said second type fuel stored in said second sub-tank;
outputting a third type fuel from said mixer, said third type fuel having a third octane rating which is a function of a mixture ratio of said first fuel type to said second fuel type; and
controlling said mixture ratio as required by operating conditions of said vehicle.

28. The method as claimed in claim 27, wherein a volume of said first type fuel filling said first sub-tank is smaller that a volume of said second type fuel filling said second sub-tank.

29. The method as claimed in claim 27, wherein said fuel mixer is positioned upstream in a fuel flow direction from a fuel injector of said motor.

30. The method as claimed in claim 27, wherein said fuel mixer is integrally configuring with a fuel injector of said motor and said controller is connected to said fuel injector, said method comprising controlling said mixture ratio at an output of said fuel injector.

31. The fuel system as claimed in claim 27, wherein said controlling comprises controlling said mixture ratio at least as a function of a compression ratio and/or a combustion chamber pressure of said motor.

32. The method as claims in claim 27, wherein:
a first fill pipe is connected to said first sub-tank, said first fill pipe comprising a first output connected to said first sub-tank and a first input to enable filling said first sub-tank with said first type fuel;
a second fill pipe is connected to said second sub-tank, said second fill pipe comprising a second output connected to said second sub-tank and a second input to enable filling said second sub-tank with said first type fuel;
said filling said first sub-tank comprising removably connecting a first output of said first source to said first input of said first fill pipe;
said filling said second sub-tank comprising removably connecting a second output of said first source to said second input of said second fill pipe;
said first output of said first source being uniquely configured to fit said first input of said first fill pipe; and
said second output of said second source being uniquely configured to fit said second input of said second fill pipe.
